(19) United States
(12) Patent Application Publication
(10) Pub. No.: US 2022/0226857 A1
(43) Pub. Date: Jul. 21, 2022

(54) APPARATUS AND METHOD FOR COATING WEBS OF MATERIAL OR SHEETS OF MATERIAL WITH HOT-MELT ADHESIVE

(71) Applicants: Ramon TOSS, Alten-Buseck (DE); Toss GmbH & Co. KG Verpackungssysteme, Alten-Buseck (DE)

(72) Inventor: Ramon TOSS, Alten-Buseck (DE)

(73) Assignees: Toss GmbH & Co., KG Verpackungssysteme, Alten-Buseck (DE); Ramon TOSS, Alten-Buseck (DE)

(21) Appl. No.: 17/611,201

(22) PCT Filed: Sep. 23, 2019
(86) PCT No.: PCT/EP2019/075518

§ 371 Date: Nov. 15, 2021

(30) Foreign Application Priority Data
May 15, 2019 (DE) 10 2019 112 788.2

(51) Int. Cl. B05C 1/08; B05C 1/00; D21H 23/56

(52) U.S. Cl. CPC B05C 1/083; D21H 23/56; B05C 1/003; B05C 1/0808

(57) ABSTRACT

An apparatus is used for coating a web of material or a sheet of material with a hot-melt adhesive (14). In order to simplify the application of hot-melt adhesive to webs of material or sheets of material, it is provided that the apparatus (10; 110) has a heated surface (25; 124) and a supply roller (16) with hot-melt adhesive (14) movable perpendicular to its axis of rotation, the web of material or the sheet of material being movable relative to the supply roller (16) while in contact with the heated surface, a pressure apparatus, which presses the supply roller (16) against the heated surface (25: 124), and a drive apparatus being provided, which drive apparatus causes the supply roller (16) to roll on the web of material or the sheet of material.

The invention relates to an apparatus for coating a web of material or a sheet of material with a hot-melt adhesive in accordance with the preamble of claim 1. The subject matter of the method is also a method for coating webs of material or sheets of material with hot-melt adhesive.

In the packaging industry, for example, efforts are being made to produce packaging, for example packaging bags, which have hitherto been made of plastics material, from more environmentally friendly materials, such as paper. However, paper cannot be welded like a plastics material film and must be provided with an adhesive or a hot-melt adhesive at least at the contact points, the so-called sealing zone. A full-surface coating is possible in the case of hot-melt adhesive, but this coating introduces an undesirably high proportion of a less readily degradable material into the environmentally friendly paper. In addition, this makes the product considerably more expensive.

The application of wet glue is relatively inexpensive and can only be applied to the packaging material where the material is to be bonded, for example with the aid of application wheels or rollers. However, the disadvantages of wet glue are that it takes a relatively long time to dry before further processing is possible. The repeatedly required cleaning of the rollers because of the deposits that form there is also a disadvantage of this method.

For this reason, the aforementioned hot-melt adhesives (hotmelts) have found widespread use. In principle, these can also be applied very well to paper or other possible packaging materials. The necessary devices are, however, quite complex and correspondingly expensive. The reason is to be seen in the supply of the adhesive in liquefied (hot) form. Lines and application nozzles require cleaning after they have been switched off, otherwise they will clog. Even if the use of hot-melt adhesive is possible in the case of the apparatuses known up to now, the acceptance of such systems by the operators of smaller systems, such as small tubular bag machines, is rather low because of the high costs and the high maintenance requirements.

The object of the invention is to create an apparatus and a method of the type mentioned at the outset which simplify the application of hot-melt adhesive onto webs of material or sheets of material.

The main features of the apparatus according to the invention are specified in the characterising part of claim 1. Embodiments are the subject matter of claims 2 to 11. The method according to the invention is the subject matter of claim 12; advantageous developments of the method are set out in claims 13 to 17. Claim 18 relates to a new type of packaging of hot-melt adhesive in connection with the apparatus according to the invention and the method according to the invention.

According to the invention, it is provided in the case of an apparatus of the type mentioned at the outset that the apparatus has a heated roller surface and a supply roller with hot-melt adhesive that is linearly movable perpendicular to its axis of rotation, the web of material or the sheet of material being movable relative to the supply roller while in contact with the heated surface, a pressure apparatus being provided which presses the supply roller against the heated surface, and a drive apparatus being provided, which drive apparatus causes the supply roller 16 to roll on the web of material or the sheet of material.

It has been shown that the apparatus according to the invention can be used in a simple manner to apply hot-melt adhesive to webs of material or sheets of material, which webs or sheets can be further processed as packaging material, for example.

The supply roller is a consumable material, and its diameter is continuously reduced during operation as the hot-melt adhesive melts and is transferred to the material. The mobility of the supply roller in the direction of the heated roller allows compensation in this case in order to guide the supply roller towards the feed roller in accordance with the decrease in diameter. A spring tensioning apparatus is preferably provided which ensures the required spring loading to ensure a desired contact pressure on the heated roller.

A switch-off apparatus is preferably provided which detects a detection of the diameter of the supply roller by detecting the position of the supply roller in its guide and, if the diameter falls below this value, switches off the apparatus before the hot-melt adhesive is completely used up.

The apparatus according to the invention is limited in its application to maximum thicknesses of webs of material or sheets of material due to the fact that the heat for melting the hot-melt adhesive is transferred from the heated surface through the material to the supply roller, since the temperature of the heated surface cannot be increased at will due to the temperature sensitivity of the packaging material. The absolute limit value for a thickness that can still be processed depends, among other things, on the properties of the material, the properties of the hot-melt adhesive used and also on the feed speed. The apparatus according to the invention is in any case particularly, but not exclusively, suitable for paper packaging, especially since only a single layer of paper is generally required there. It is less suitable for processing thicker cardboard boxes.

However, it should be mentioned as an advantage over hot-melt adhesive applied by means of hot nozzles that the material is also heated to the melting temperature of the hot-melt adhesive, so that a particular holding strength of the hot-melt adhesive on the material is achieved.

In a first embodiment of the invention, it is provided that the heated roller surface is designed as a heated surface of a feed roller driven by a drive, which drive forms the drive apparatus, the supply roller being movably guided in a linear guide.

In this way, it is possible to dispense with an additional drive apparatus and in total only two rollers are required for the application and the feed. Alternatively, the drive can also moves the heated roller only synchronously with the drive of the web of material brought about by further feed means in order to compensate for friction losses due to the adhesion of the adhesive or from electrical sliding contact for electrical heating.

If the frictional forces in the region of the rollers for the hot-melt adhesive application are low, it is sufficient to passively drag the supply roller and the heated roller through the web of material, this having the advantage that the contact pressure of the supply roller on the heated roller can be adjusted solely based on the aspects of the application of adhesive, and the aspects of the friction entrainment by an actively driving heated roller can be dispensed with. A drive of the heated roller that supports only synchronously also allows a variable contact pressure.

As an alternative to a web of material guided between two rollers, it can be provided that the supply roller is movably driven in such a way that, in an application zone in the region of the heating surface, the supply roller rolls on the web of material or the sheet of material.

Depending on the embodiment of a packaging system, this kinematics may be preferred. The kinematics of the roller correspondingly guided so as to be rolled on a surface is somewhat more complex in this embodiment; on the other hand, the heating surface is formed statically on a stationary, flat heating jaw, which heating jaw is usually longer than an application zone formed by the roll-on region of the supply roller.

In order to define the application zone exactly, it is preferably provided that the application zone is delimited by support regions for the supply roller, on which regions the supply roller is spatially separated from the web of material or the sheet of material. The support regions mask the boundaries of the application zone so that the hot-melt adhesive is only applied in an exactly defined region and no hot-melt adhesive can pass into undesired regions of the material.

In order to allow a uniform transition movement for the roller from the support regions into the application zone and to be able to wipe off adhesive residues better, if necessary, the two support regions have ramps as a transition to the application zone. The roller touches the material as it moves and is also lifted off again in a corresponding manner, so that it is reliably avoided that no flattening can result from local melting, as could be the case with linear pressing.

As already mentioned, in the field of packaging systems, the web of material or the sheet of material is preferably made of paper, but fabrics, textiles or films can also be processed.

In a particularly preferred embodiment of the invention, it is provided that the width of the supply roller for carrying out a partial coating is made narrower than the web of material or the sheet of material.

This allows the hot-melt adhesive to be applied in strips without any particular technical effort, the regions of the web of material lying to the side of these strips shielding the heated feed roller so that no melted hot-melt adhesive can pass onto it and contaminate it.

The aforementioned apparatus can easily be combined with packaging machines of a known type which, for example, have a device for bonding the coated web of material to a further layer of the material. This usually takes place in a sealing zone in which the required heat is introduced into the material, whereby any residual heat that may still be present from the application of the hot-melt adhesive can also be used.

In order to be able to arrange the supply roller more easily on a bearing shaft, it is preferably also provided that the supply roller has a bearing sleeve between the hot-melt adhesive material and its bearing.

As a result, the supply roller can easily be exchanged after it has been used up, the bearing sleeve providing a defined connection. In simple applications, the bearing sleeve can be designed as a simple cardboard sleeve, but higher quality materials can also be used for heavy supply rollers or particular requirements for the guide.

As already mentioned, the subject matter of the present invention is also a method, which can be carried out by means of an apparatus described above, for coating a web of material or a sheet of material, which is characterised in that the web of material or the sheet of material is moved relative to a supply roller, a heat input into the web of material or the sheet of material taking place by means of a heating surface, and a supply roller, which has a supply of hot-melt adhesive, being pressed in the direction of the heated roller and melted on its pressure surface, so that the hot-melt adhesive is transferred across the width of the supply roller to the web of material or the sheet of material.

As already mentioned, one possible embodiment of the method is to heat the surface of a heated roller and to bring about the feeding by driving the heated roller in the direction of rotation so that no further rollers are required to feed the material. The advantages and disadvantages of the various drive concepts have already been discussed in connection with the apparatus.

For an even application of adhesive and an even consumption of the supply roll, it may be advantageous to design the method in such a way that, in an application zone, the supply roller 16 is rolled on the web of material or the sheet of material, the application zone being heated by a flat heating surface.

As already explained in connection with the apparatus, the method can in particular provide that a web of paper or a sheet of paper is glued and, regardless of the material, an embodiment of the method is preferred in which the hot-melt adhesive is applied only as a strip to the web of material or the sheet of material.

In a preferred development of the method, the hot-melt adhesive strip formed in this way is optionally bonded to a further layer of material in the same apparatus in a sealing zone.

According to the invention, a hot-melt adhesive supply is also proposed for packaging, which is designed as a roller with a solid, cylindrical hot-melt adhesive application on a bearing sleeve. While hot-melt adhesive has so far been fed to the systems in the form of sticks, the new packaging as a roller is matched to the apparatus described above.

Further features, details and advantages of the invention will become apparent from the wording of the claims and from the following description of embodiments by way of the drawings, in which:

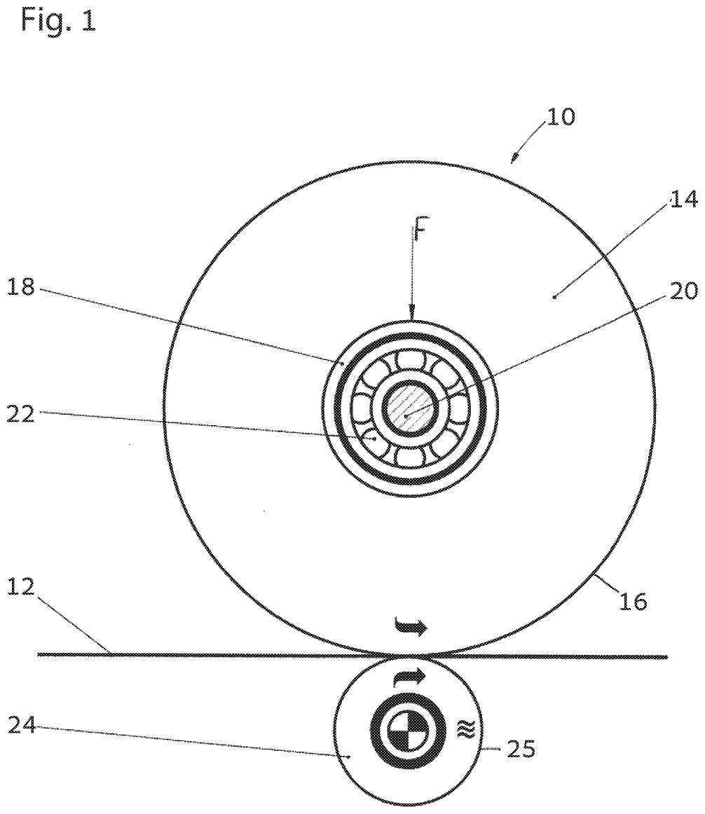

FIG. 1 is a schematic side view of a first embodiment of an apparatus for coating a material:

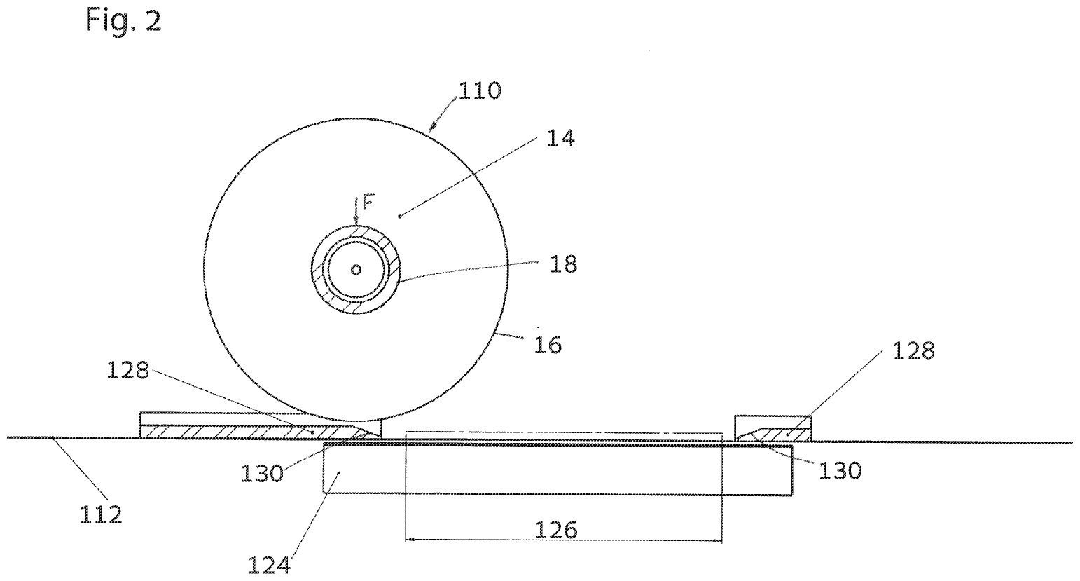

FIG. 2 is a schematic side view of a further embodiment of an apparatus for coating a material.

FIG. 1 shows an apparatus 10 for continuously coating a web of paper 12 with a hot-melt adhesive 14. The hot-melt adhesive 14 forms a substantial part of a supply roller 16, the hot-melt adhesive 14 being applied to a cardboard sleeve 18 as a cylindrical application.

The supply roller 16 is rotatably mounted on an axis of rotation 20 by means of ball bearings 22, the axis of rotation 20 being mounted so as to be linearly displaceable in the vertical direction in the sense of the illustration. A pressure mechanism (not shown) builds up a pressure force F which is directed downwards in the direction of a heated roller 24 in the sense of the illustration.

Between the supply roller 16 and the heated roller 24, the web of paper 12 can be moved by means of the heated roller 24 designed as a driven feed roller, the feed forces required for this movement being transferred by friction, which forces result from the pressure force of the supply roller 16. However, it is also possible to provide a separate drive and to pull the web of paper through between the then passively co-rotating rollers.

The web of paper 12 is made wider than the supply roller 16, so that only one strip of hot-melt adhesive 14 is applied to the web of paper 12, because it is usually sufficient to provide the web of paper 12 with a hot-melt adhesive application only at the points which application is to be bonded later to another layer.

In order to be able to apply the hot-melt adhesive 14 to the web of paper 12, the possibly driven heated roller 24 is correspondingly strongly heated on a heated surface 25. The temperature is set so that the hot-melt adhesive 14 on the top layer on the circumference of the supply roller 16 is heated above its melting point, the intermediate web of paper 12 reaching a corresponding temperature. The melted hot-melt adhesive 14 is thereby continuously applied as a strip to the web of paper 12 running through. The temperature of the heated roller 24 depends on the feed speed, the material properties of the web of paper or another web of material to be processed as well as its thickness, the hot-melt adhesive used of course also having an influence. It goes without saying that the melting temperature of the hot-melt adhesive must be below a temperature limit of the material above which the paper or other packaging material could suffer thermal damage.

The continuous application of hot-melt adhesive 14 to the web of paper 12 reduces the diameter of the supply roller 16 in a corresponding manner. In order to ensure permanent contact of the supply roller 16 with the heated roller 24, the aforementioned movable bearing of the supply roller 16 is provided, which, over the service life of the supply roller regardless of the current position the supply roller 16, ensures correct contact pressure in conjunction with a pressure apparatus, which pressure apparatus for example has one or more pressure springs.

A position sensor (not shown) is provided to detect the position of the axis of rotation 20. This makes it possible to determine when the supply roller has reached its wear limit, so that it can be replaced before the hot-melt adhesive 14 is completely used up.

As already mentioned, packaging materials other than paper can also be processed, it possibly being necessary to adapt the temperature of the heated roller 24, the feed speed, the contact pressure of the two rollers against one another and/or the hot-melt adhesive 14 used, it being possible for the latter to take place by simply exchanging the supply roller.

The apparatus 10 shown in FIG. 1 can be integrated into a more complex packaging machine, for example a tubular bag machine (not shown), in which the web of paper 12 coated with hot-melt adhesive 14 is further processed directly into a bag by bonding in the sealing zones.

As already discussed, the feed can be carried out by a drive of the heated roller, which is then designed as a feed roller. A more flexible adjustability of the pressure force can be achieved in the case of a heated roller 24 that runs only passively, a drive of the heated roller 24 in connection with a further drive also being possible, which drive accomplishes the actual feed movement of the web of paper or of another workpiece. In this case, the correspondingly weaker dimensioned drive of the heated roller 24 moves the roller synchronously with the feed movement, without itself exerting feed forces on the material.

In FIG. 2, a further embodiment of an apparatus 110 for applying hot-melt adhesive to a web of paper 112 is shown. In this case, a practically identical supply roller 16 is used as in the embodiment described above, which supply roller is only moved in a somewhat different manner relative to the material.

In the apparatus 112, the web of material 112 is moved over a heating surface 125 of a heating jaw 124, an application zone 126 being delimited by two support regions 128 for the supply roller 16. Ramps 130 are provided between the support regions 128 and the application zone 126, which allow a gentle transition movement of the supply roller 16 from the support regions 128 into the application zone 126.

The process of coating the web of paper with hot-melt adhesive 14 is as follows. The supply roller 16 is first lowered onto one of the unheated support regions 128. This takes place within a linear guide already mentioned in connection with the previous embodiment, which also allows the readjustment movement of the supply roller 16 as the diameter of the supply roller 16 decreases.

From a position in a support region, the supply roller 16 for applying hot-melt adhesive is moved around its axis of rotation parallel to the web of paper without driving the supply roller 16, it being possible for the supply roller, by means of the previously described linear guide, to gently rest against the web of paper 112 after leaving the ramp 130, the supply roller leaving the application zone 126 again at the opposite ramp 130 in order to pass into the opposite support region 128. Accordingly, the path of movement of the supply roller parallel to the web of paper 112 is longer than the application zone 126. It has been shown that by rolling the supply roller 16 in the application zone 126 without the roller being self-driven in the direction of rotation or the web of paper 112 being driven, a particularly uniform hot-melt adhesive application is made possible, and the supply roller is also consumed more evenly, i.e. fewer flat spots due to local melting processes are formed on the circumference of the supply roller 16.

For the heated surfaces, preferred impulse heating systems are used, which heating systems can be switched on and off again immediately. This avoids heating-up times that have to be taken into account when using conventional heating cartridges.

The invention is not restricted to one of the embodiments described above but may be modified in many ways.

All of the features and advantages arising from the claims, the description and the drawings, including structural details, spatial arrangements and method steps, may be substantial to the invention both individually and in a wide variety of combinations.

### LIST OF REFERENCE SIGNS

10 Apparatus for applying hot-melt adhesive
12 Web of paper
14 Hot-melt adhesive
16 Supply roller
18 Cardboard sleeve
20 Axis of rotation
22 Ball bearing
24 Feed roller/heated roller
25 Heated surface
110 Apparatus for applying hot-melt adhesive
112 Web of paper
124 Heating jaw
126 Application zone
128 Support regions
130 Ramps

1. Apparatus for coating a web of material or a sheet of material with a hot-melt adhesive (14), characterised in that the apparatus (10; 110) has a heated surface (25; 124) and a supply roller (16) with hot-melt adhesive (14) movable perpendicular to its axis of rotation, the web of material or the sheet of material being movable relative to the supply roller (16) while in contact with the heated surface, a pressure apparatus, which presses the supply roller (16) against the heated surface (25: 124), and a drive apparatus being provided, which drive apparatus causes the supply roller (16) to roll on the web of material or the sheet of material.

2. Apparatus according to claim 1, characterised in that the heated surface is designed as a heated surface (25) of a feed roller (24) driven by a drive, which drive forms the drive apparatus, the supply roller (16) being movably guided in a linear guide.

3. Apparatus according to claim 1, characterised in that the supply roller (16) is movably driven in such a way that, in an application zone (126) in the region of the heating surface, the supply roller rolls on the web of material or the sheet of material.

4. Apparatus according to claim 3, characterised in that the heating surface is formed on a flat heating jaw (124) and is longer than the application zone (126) formed by the roll-on region of the supply roller (16).

5. Apparatus according to claim 3, characterised in that the application zone (126) is delimited by support regions (128) for the supply roller, on which regions the supply roller (16) is spatially separated from the web of material or the sheet of material.

6. Apparatus according to claim 5, characterised in that the two support regions (128) have ramps (130) as a transition to the application zone (126).

7. Apparatus according to claim 1, characterised in that the web of material or the sheet of material consists of paper.

8. Apparatus according to claim 1, characterised in that the width of the supply roller (16) for carrying out a partial coating is made narrower than the web of material or the sheet of material.

9. Apparatus according to claim 1, characterised in that the heated surface (25; 124) is designed to be wider than the supply roller (16).

10. Apparatus according to claim 1, characterised in that it has a device for bonding the coated web of material to a further layer of the material.

11. Apparatus according to claim 1, characterised in that the supply roller (16) has a bearing sleeve (18) between the hot-melt adhesive (14) and its bearing (22).

12. Method for coating a web of material or a sheet of material, characterised in that the web of material or the sheet of material is moved relative to a supply roller (16), a heat input into the web of material or the sheet of material taking place by means of a heating surface (25; 124), and the supply roller (16), which has a supply of hot-melt adhesive (14), being pressed in the direction of the heating surface (24) and melted at its pressure point, so that the hot-melt adhesive (14) is transferred across the width of the supply roller (16) to the web of material or the sheet of material.

13. Method according to claim 12, characterised in that the surface of a roller (16) is heated to form the heating surface and the correspondingly heated roller (24) is driven in order to move the web of material or the sheet of material.

14. Method according to claim 12, characterised in that, in an application zone, the supply roller (16) is rolled on the web of material or the sheet of material, the application zone being heated by a flat heating surface (124).

15. Method according to claim 12, characterised in that a web of paper (12) or a sheet of paper is processed.

16. Method according to claim 12, characterised in that the hot-melt adhesive (14) is applied only as a strip to the web of material or the sheet of material.

17. Method according to claim 16, characterised in that the strip provided with hot-melt adhesive (14) is bonded to a further layer of material in a sealing zone.

18. Hot-melt adhesive supply, characterised in that it is designed as a supply roller (16) with a solid, cylindrical hot-melt adhesive application (14) on a rotatable bearing sleeve (18).
